(19) United States
(12) Patent Application Publication
(10) Pub. No.: US 2017/0349260 A1
(43) Pub. Date: Dec. 7, 2017

(54) HYBRID BALLOON-MULTICOPTER AND METHOD

(71) Applicant: James Richard Lawson, Seattle, WA (US)

(72) Inventor: James Richard Lawson, Seattle, WA (US)

(21) Appl. No.: 15/169,766

(22) Filed: Jun. 1, 2016

(51) Int. Cl. B64B 1/34; B64B 1/32

(52) U.S. Cl. CPC B64B 1/34; B64B 1/32; B64B 2201/00

(57) ABSTRACT

The embodiment described herein is a hybrid balloon-multicopter invention. In a similar manner to a multicopter, it incorporates anticlockwise and clockwise rotating rotors to support maneuverability in three dimensional space. However, unlike a multicopter, maneuverability is augmented by the lift force generated by a balloon filled with a lighter than air gas. Furthermore, to support extended day and night operation, one embodiment of the invention includes photovoltaic cells to convert solar energy to electric energy recharging a battery.

### TECHNICAL FIELD

The disclosure relates generally to the field of aeronautical engineering. More particularly, the device and method relate to a balloon and helicopter of the unmanned drone type. Specifically, to a helicopter of the multicopter type and a navigable balloon containing a lighter than air gas. Notably, the disclosure exhibits high application potential in, but is not limited to the fields of aerial surveying, stratospheric balloons and telecommunications.

### BACKGROUND ART

Historically, multicopters have been used for aerial surveying because of their ability to hover and accurately follow a course in three dimensional space. The current solutions comprising multicopters do not combine said multicopters with the methods and design features of a navigable balloon.

There is notably known from document U.S. Pat. No. 3,053,480 A a solution proposing an omni-directional, vertical-lift, helicopter drone.

Historically, balloons have been used to study the atmosphere because of their low cost compared to satellites and their ability to linger for a long duration within the middle layer of the atmosphere between 12 km and 45 km, making them particularly promising in respect to a range of applications; notably in the field of telecommunications. Winds in the middle layer of the atmosphere are layered and each layer varies in speed and direction. The current solutions adjust the volume and density of a lighter than air gas to change the altitude of the balloons and by floating in the different layers of winds; control latitudinal and longitudinal position. The current solutions comprising navigable balloons do not combine said balloons with the methods and design features of a multicopter.

There is notably known from document U.S. Pat. No. 621,195 A a solution proposing a navigable balloon.

Current solutions combine balloons and photovoltaic means to provide electrical energy and support extended day and night operation. The current solutions comprising balloons with photovoltaic means do not combine said means with a method of orientating said means in 3 axis to control the amount of solar energy captured.

There is notably known from document US 20130126668 A1 a solution proposing a balloon comprising photovoltaic means and a solar concentration device.

### SUMMARY OF INVENTION

### Technical Problem

A quadcopter can be maneuvered in three dimensional space. However, quadcopters require the constant dissipation of an energy source to stay aloft, Conversely, a balloon cannot be maneuvered in three dimensional space. However, balloons do not require the constant dissipation of an energy source to stay aloft.

Changing the altitude of a balloon to control latitudinal and longitudinal position is dependent on the availability of a map of the different layers of winds and provides for only limited control of the position of a balloon. Furthermore, changes in position are limited by the speed and direction of the prevailing winds.

### Solution to Problem

The solution of the problem is to combine the design features and methods of a multicopter and a balloon in a hybrid balloon-multicopter.

### Advantageous Effects of Drawing

It is the general objective of the invention to increase the duration a multicopter can stay aloft.

Another objective of the invention is, as a result the addition of the lift force generated by a balloon; to increase the bank and pitch angle that is possible in stable flight by a multicopter. Consequently, allowing a majority of the force generated by a multicopter to be vectored in the horizontal direction; overcoming the aerodynamic drag of a balloon and generating longitudinal and latitudinal velocity.

Yet another objective of the invention is the ability to reduce the complexity and increase the margin of acceptable error involved in the task of transitioning from vertical to horizontal flight by the assistance of the lift force generated by a balloon.

Yet another objective of the invention is the ability to maneuver a balloon in three dimensional space.

Yet another objective of the invention is the ability to convert solar energy to electric energy to support extended day and night operation.

Yet another objective of the invention is the ability to optimise the design of the rotor blades of a multicopter for for an atmospheric pressure that compliments the lift force generated by a balloon; which is generally reduced with altitude.

### BRIEF DESCRIPTION OF DRAWINGS

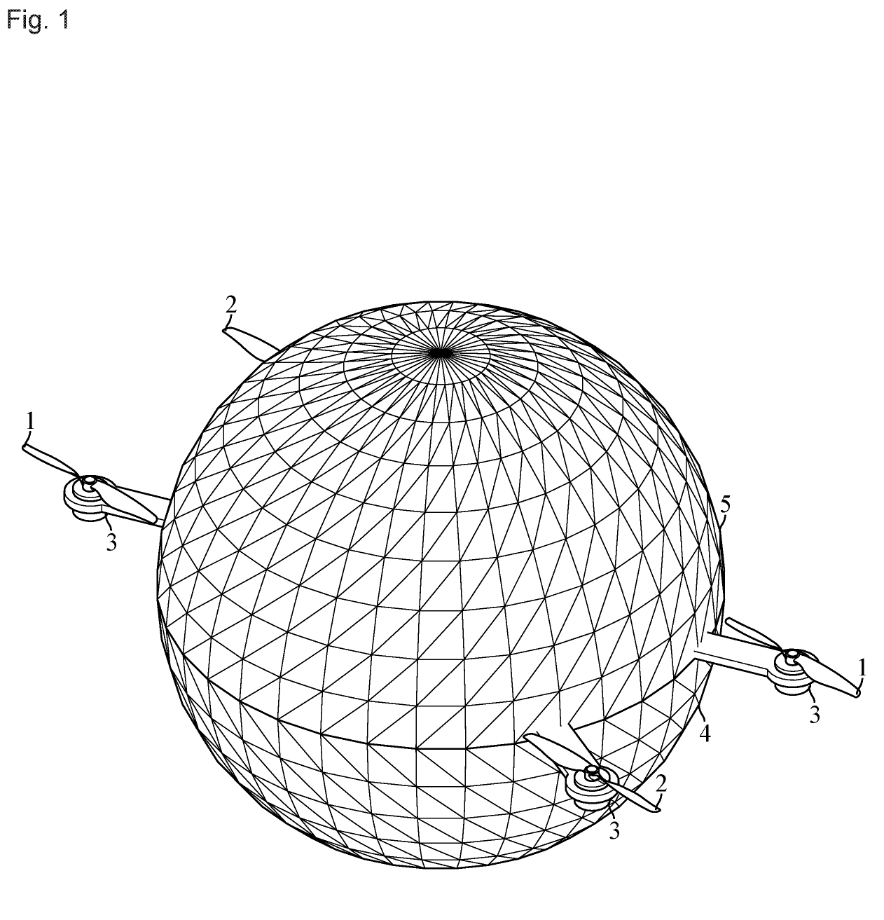

FIG. 1 is an isometric view of the invention according to one embodiment.

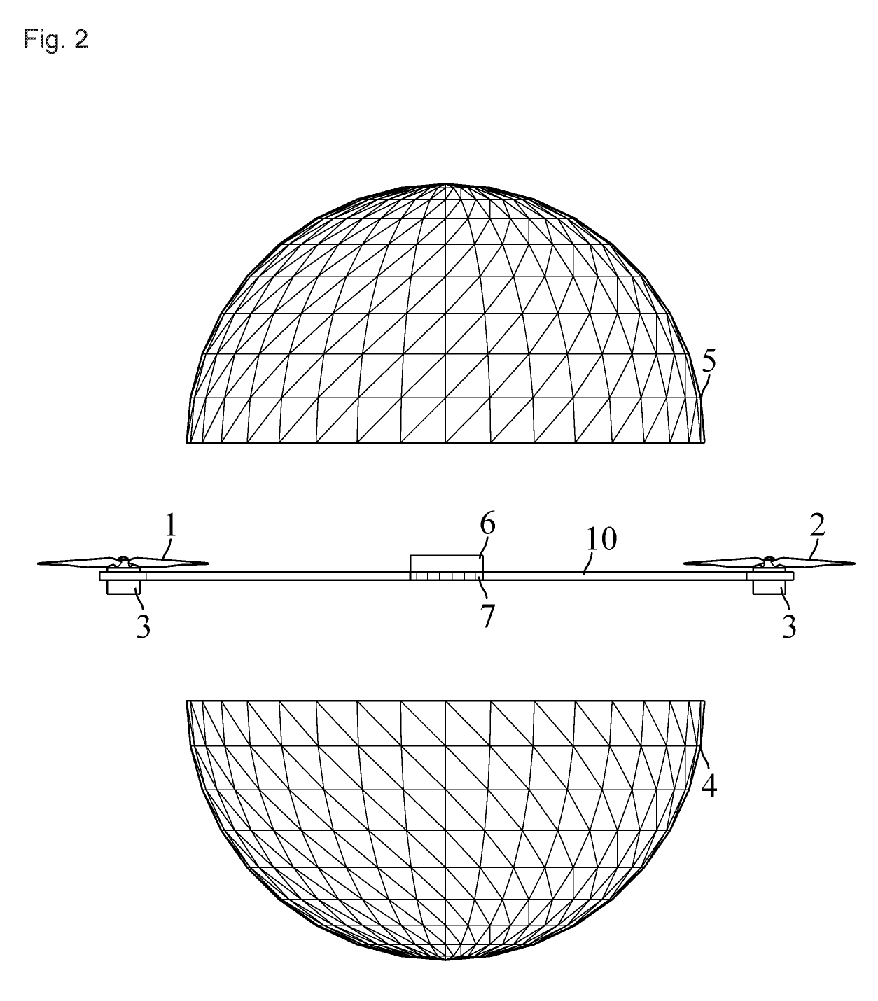

FIG. 2 is an exploded front view of the invention according to one embodiment.

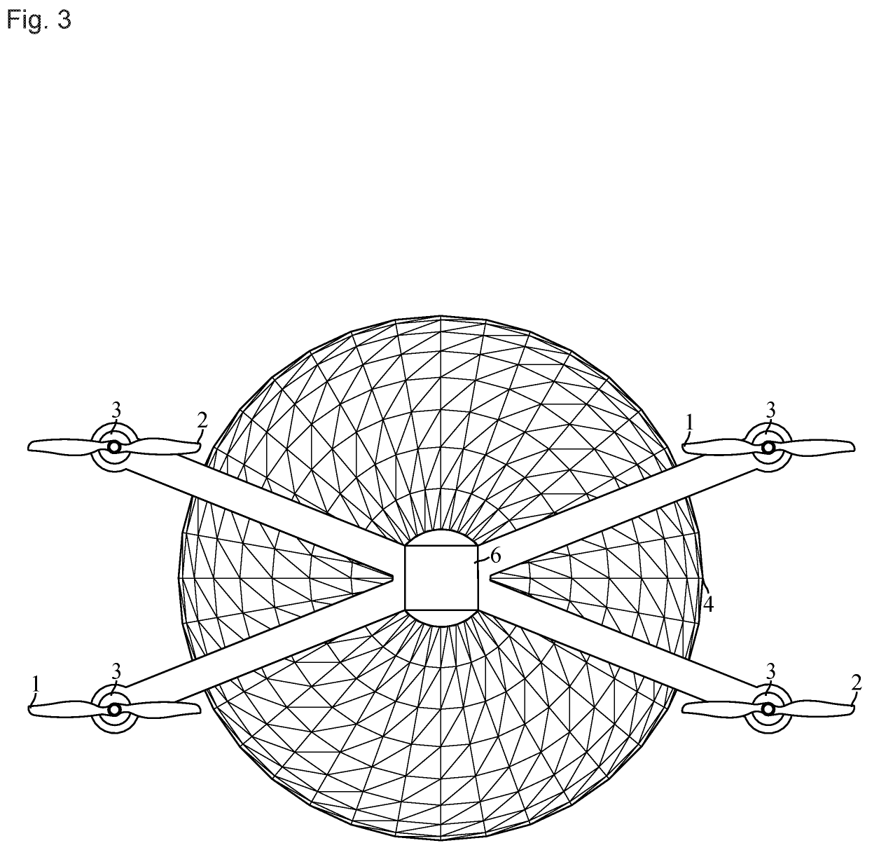

FIG. 3 is a sectional top view through the center point of the invention according to one embodiment.

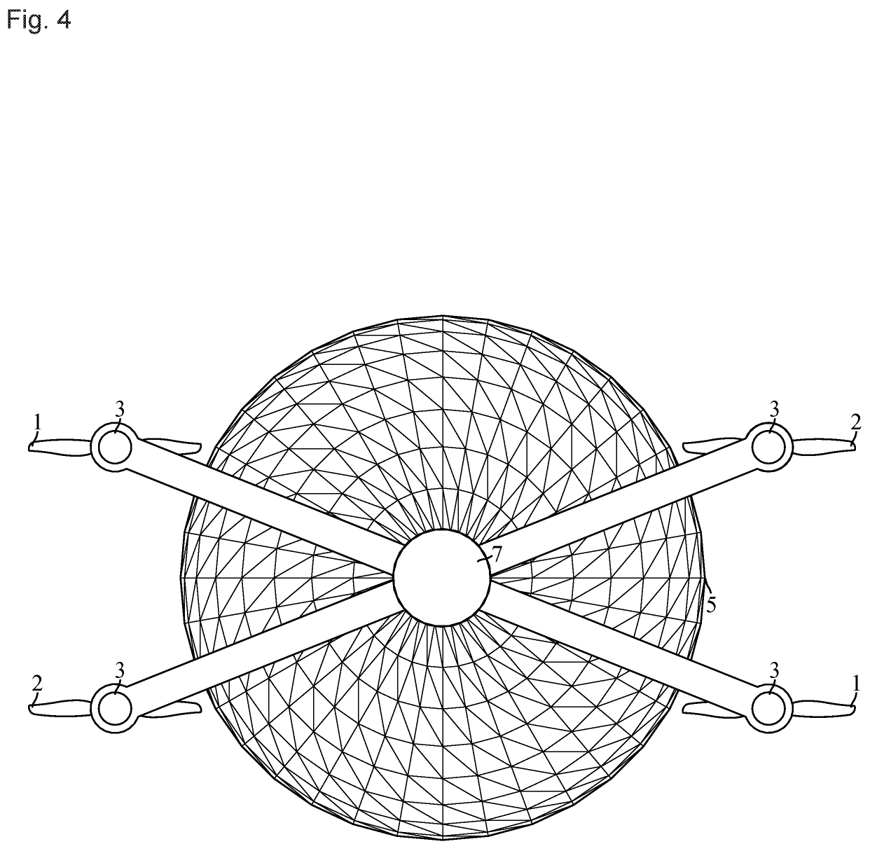

FIG. 4 is a sectional bottom view through the center point of the invention according to one embodiment.

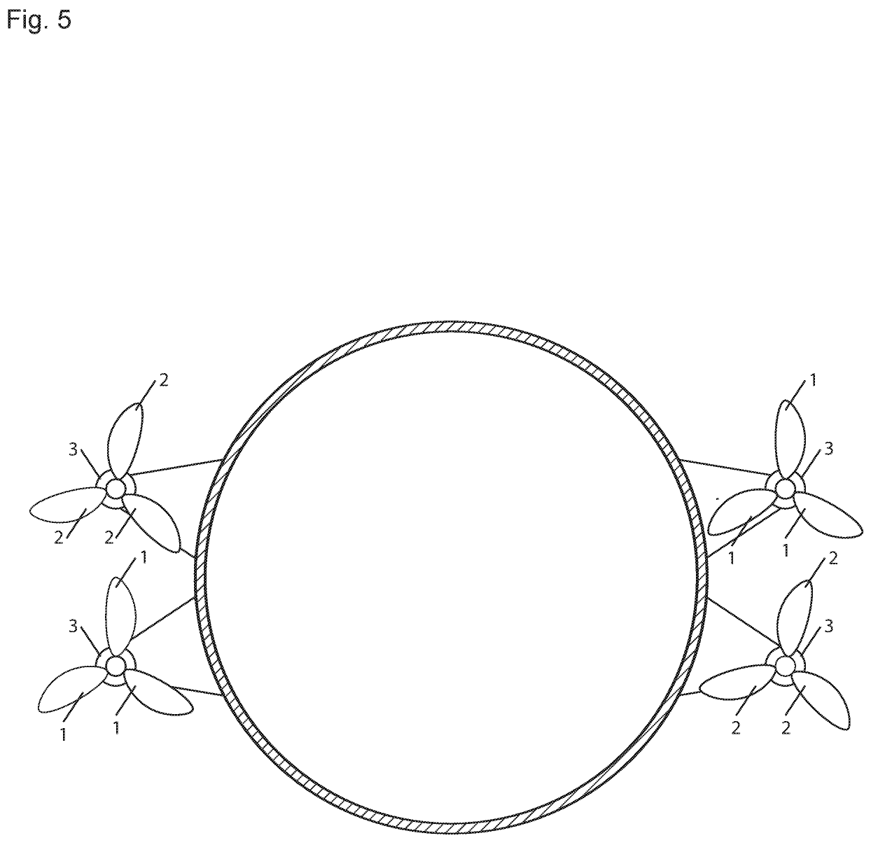

FIG. 5 is a sectional top view through the center point of the invention according to one embodiment that does not include a structural element inside the outer surface of the balloon.

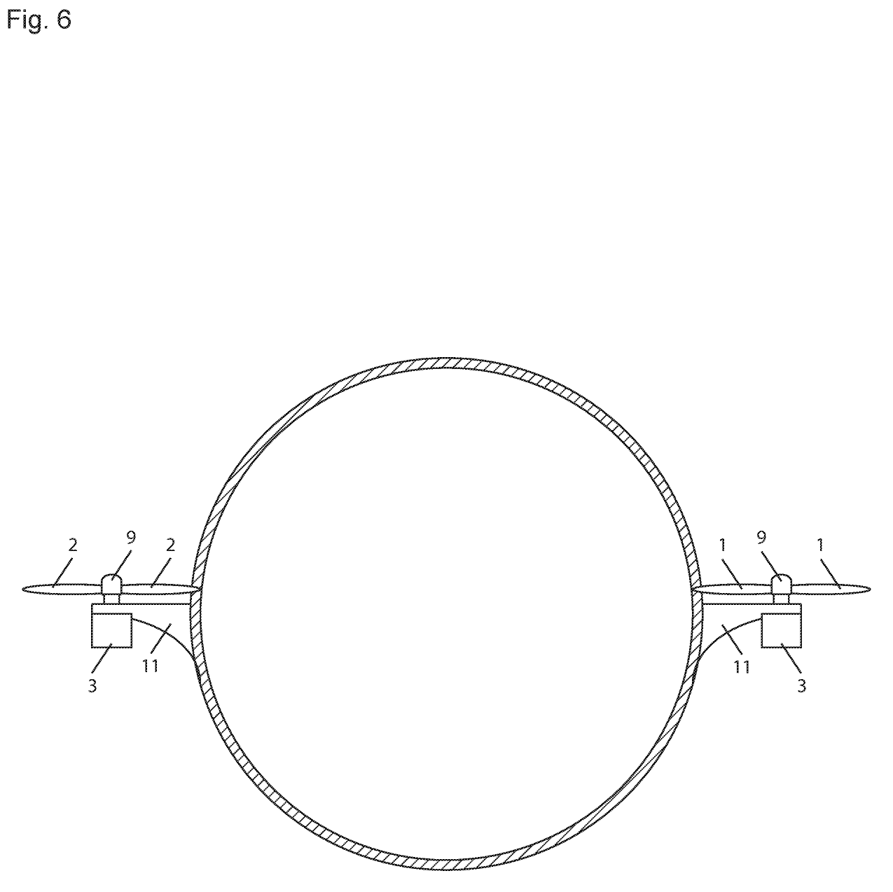

FIG. 6 is a sectional front view through the center point of the invention according to one embodiment that does not include a structural element inside the outer surface of the balloon.

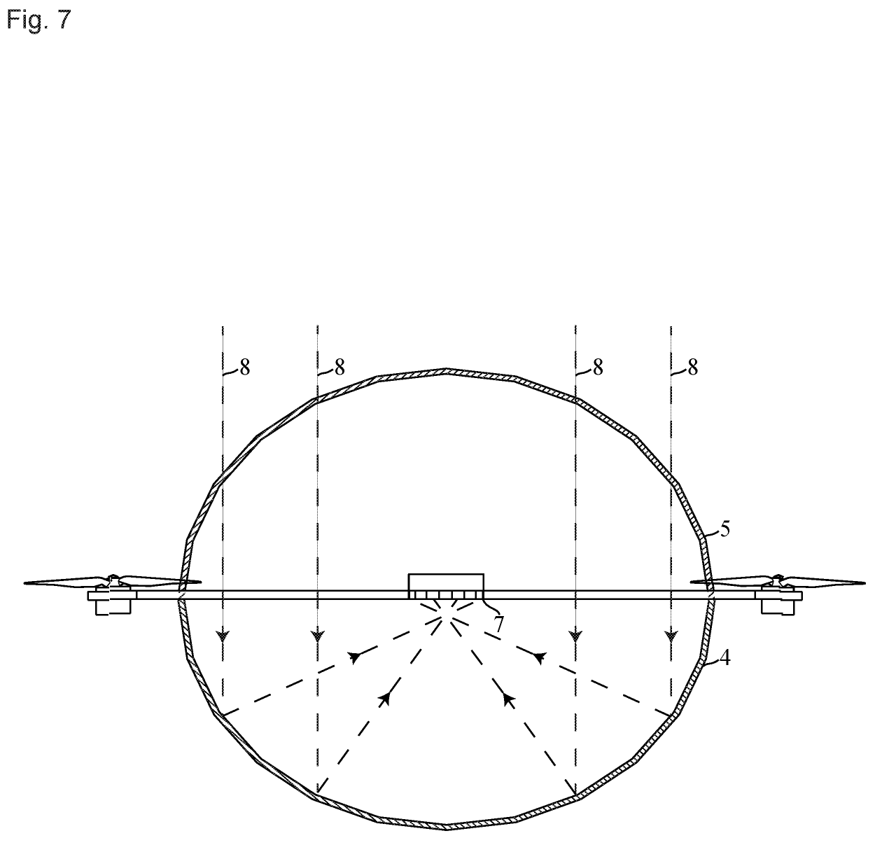

FIG. 7 is a sectional front view through the center point of the invention showing the path of the solar rays to the photovoltaic means according to one embodiment.

### DESCRIPTION OF EMBODIMENTS

The drawings of FIGS. 1, 2, 3, 4, 5, 6 and 7 depict embodiments of the invention. The invention has a pair of rotors that rotate in the anticlockwise direction 1 and a pair of rotors that rotate in the clockwise direction 2. The rotors are connected to electric motors 3. The rotor blades are connected to each other and to the electric motors via cone shaped electric motor hubs 9 so as to reduce aerodynamic drag.

A multicopter of the quadcopter type yaws in one direction by increasing the speed of a diagonally opposite rotor pair and decreasing the speed of the other rotor pair. The device banks in one direction by increasing the speed of the left or right rotor pair and decreasing the speed of the other rotor pair. The device pitches in one direction by increasing the speed of the front or back rotor pair and decreasing the speed of the other rotor pair. Altitude is controlled by increasing or decreasing the speed of all rotors. Horizontal motion is achieved by first banking or pitching and then increasing the overall speed of all rotors.

Generally, the prefered configuration is four rotors and two diagonally opposite rotor pairs. However, according to one variation of the invention, a plurality of rotors numbering in excess of four exists. The variation of the invention may incorporate two rotor groups of three or four or more rotors. In a similar manner to the preferred configuration, the first rotor group may rotate anticlockwise and the second rotor group may rotate clockwise.

According to one variation of the invention, a first zone 5 of the balloon may be made of a transparent material and a second zone 4 of the balloon may be made of an opaque material with a reflective inner surface. The first zone 5 conducts solar rays 8. to the second zone 4. The second zone 4 functions as a solar energy concentrator to direct solar rays 8 to a photovoltaic means 7, The photovoltaic means 7 converts solar energy to electric energy. The electric energy may be used to charge a battery 6 to support extended day and night operation of the invention.

Generally, the preferred invention has a balloon of a spherical shape. However, according to one variation of the invention, the balloon has an ellipsoid shape FIG. 7. The geometry of the ellipsoid shape may be chosen to adjust the focal point and optimise the convergence of the solar rays 8 towards the photovoltaic means 7.

The position of the invention in three dimensional space may be controlled remotely via an RF antenna.

The position of the invention in three dimensional space may be determined by the combination of a global positioning system, an inertial reference system or the combination of the two.

The invention may operate in an autonomous mode without the need to be controlled remotely.

The invention, to provide additional rigidity to the mounting platform for the rotors, may include one or more structural elements 10 partially enveloped by the outer surface of the balloon. Alternatively, the invention may include one or more structural elements 11 connected to the outer surface of the balloon. To provide added structural rigidity, the structural elements may be connected to each other.

1. An invention comprising; a navigable balloon filled with a lighter than air gas; and a multicopter having motors wherein the speed of different combinations of said motors can be changed causing the balloon to yaw, pitch, roll and change position in three dimensional space.

2. The invention of claim 1 wherein the sum of all anticlockwise and clockwise moments is zero with respect to the fulcrum (at or near the center of gravity of the invention) when the speed of said motors is equal.

3. The invention of claim 1 having photovoltaic means.

4. The invention of claim 1 wherein either said balloon or said multicopter has utility, is removable and can be operated independently of the other.
